(19) United States
(12) Patent Application Publication
(10) Pub. No.: US 2010/0072897 A1
(43) Pub. Date: Mar. 25, 2010

(54) LED LAMP

(75) Inventor: SHI-SONG ZHENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/398,969

(22) Filed: Mar. 5, 2009

(30) Foreign Application Priority Data
Sep. 19, 2008 (CN) 200810304583.1

(51) Int. Cl. H01J 61/52; H05B 37/02

(52) U.S. Cl. 315/113; 315/297

(57) ABSTRACT

An LED lamp includes a bracket, a plurality of first LED modules mounted on a center of the bracket, a second LED module mounted on a foreside of the bracket and spaced from the first LED modules, and a driving circuit board mounted on a rear end of the bracket and electrically connecting with the second LED module and the first LED modules. The driving circuit board comprises a chip automatically monitoring operating status of the first LED modules and automatically controlling activation of the second LED module when failure occurs on at least one of the first LED modules.

### BACKGROUND

1. Field of the Disclosure

The present disclosure generally relates to LED (light emitting diode) lamps, and more particularly to an LED lamp having complementary light sources for compensating light.

2. Description of Related Art

An LED lamp is a type of solid-state lighting that utilizes LEDs as a source of illumination. The LED lamp is intended to be a cost-effective yet high quality replacement for incandescent and fluorescent lamp due to its long-term reliability, environment friendliness, and low power consumption.

A conventional LED lamp comprises a plurality of LED modules, each of which includes a plurality of LEDs. With prolonged use, the LEDs thereof are easily damaged, resulting in significantly diminished brightness of the LED lamp.

What is needed, therefore, is an LED lamp having complementary light sources to maintain the brightness of the LED lamp.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an LED lamp in accordance with an exemplary embodiment of the present disclosure.

FIG. 2 is an exploded view of the LED lamp of FIG. 1.

FIG. 3 is an inverted view of FIG. 2.

FIG. 4 is an exploded, enlarged view of a second LED module and a heat-absorbing member of the LED lamp of FIG. 3.

FIG. 5 is an exploded, enlarged view of a first LED module of the LED lamp of FIG. 3.

### DETAILED DESCRIPTION

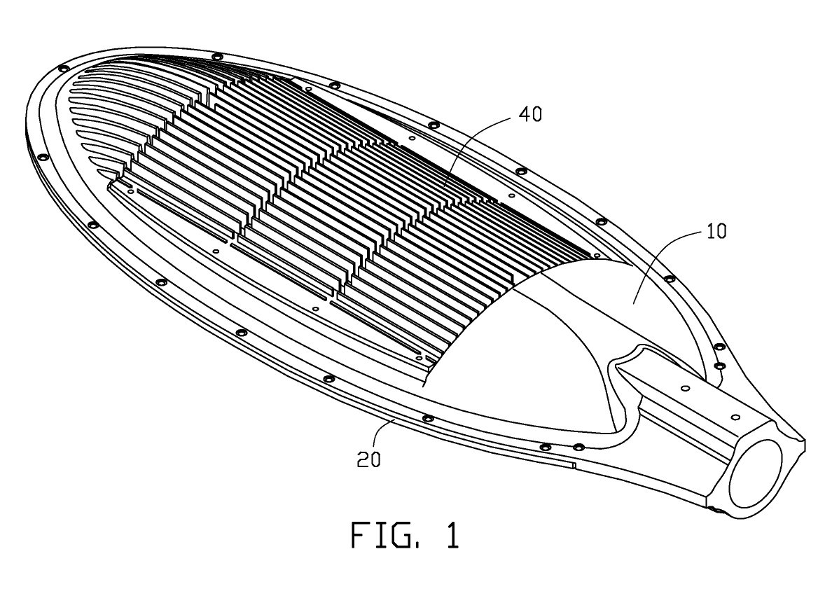

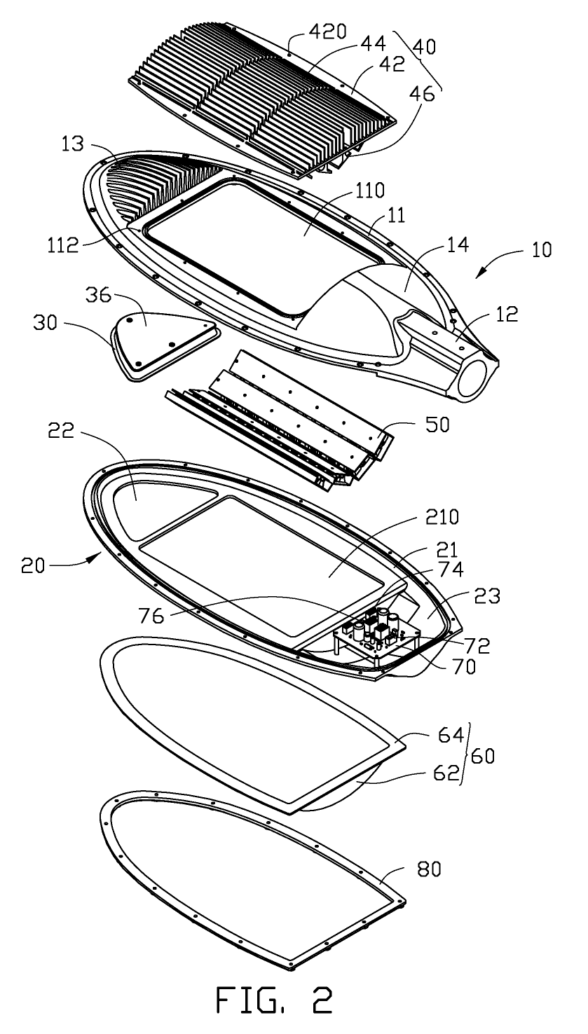

Referring to FIGS. 1-2, an LED lamp in accordance with an exemplary embodiment of the present disclosure comprises a bracket 10, a lamp shell 20 on a bottom side of the bracket 10, a heat sink 40 on a top side of the bracket 10, a plurality of first light source modules 50 on a bottom side of the heat sink 40, a second light source module 30 sandwiched between the bracket 10 and the lamp shell 20, and a transparent envelope 60 on bottom side of the lamp shell 20 covering the first light source modules 50 and the second light source module 30.

Particularly referring to FIG. 2, the bracket 10, integrally formed as a single piece, comprises a substantially elliptic fixing frame 11 and a lamp holder 12 located at a rear end of the fixing frame 11. A rectangular opening 110 is defined in a center of the fixing frame 11. A plurality of parallel fins 13 spaced from each other and a convex portion 14 are located at two opposite sides of the rectangular opening 110. The convex portion 14 is located between the rectangular opening 110 and the lamp holder 12, which connects the LED lamp to a supporting structure, such as a post.

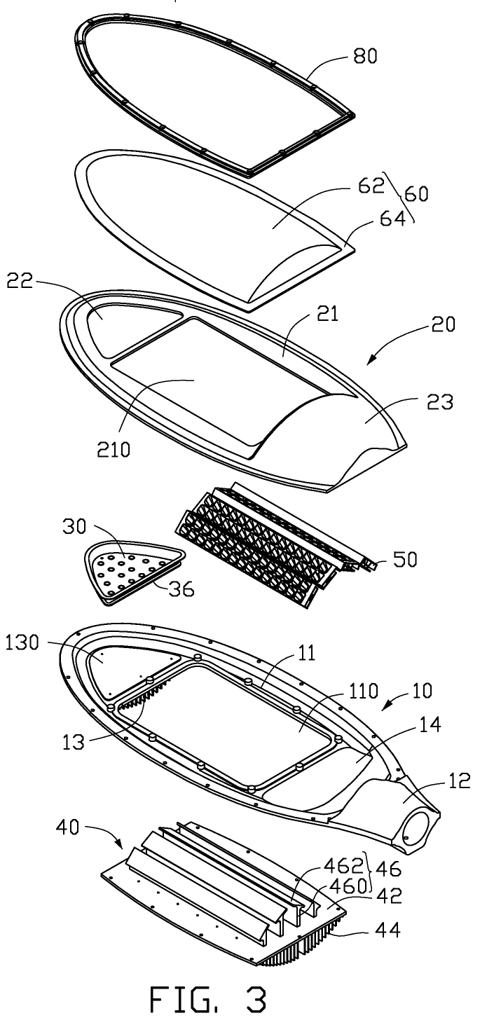

Referring to FIG. 3 also, the lamp shell 20, integrally formed as a single piece, comprises a mounting frame 21. The mounting frame 21 has the same profile as the fixing frame 11 of the bracket 10. The mounting frame 21 defines a rectangular window 210 corresponding to the rectangular opening 110 of the fixing frame 11. A triangular opening 22 corresponding to the fins 13, and a recess 23 depressed downwardly opposite to the convex portion 14 of the bracket 10, are located at two opposite sides of the rectangular window 210. The recess 23 and a chamber (not labeled) enclosed by the convex portion 14 of the bracket 10 cooperatively define a slot (not labeled) receiving a driving circuit board 70 therein. The driving circuit board 70 electrically connects the second light source module 30 and the first light source modules 50.

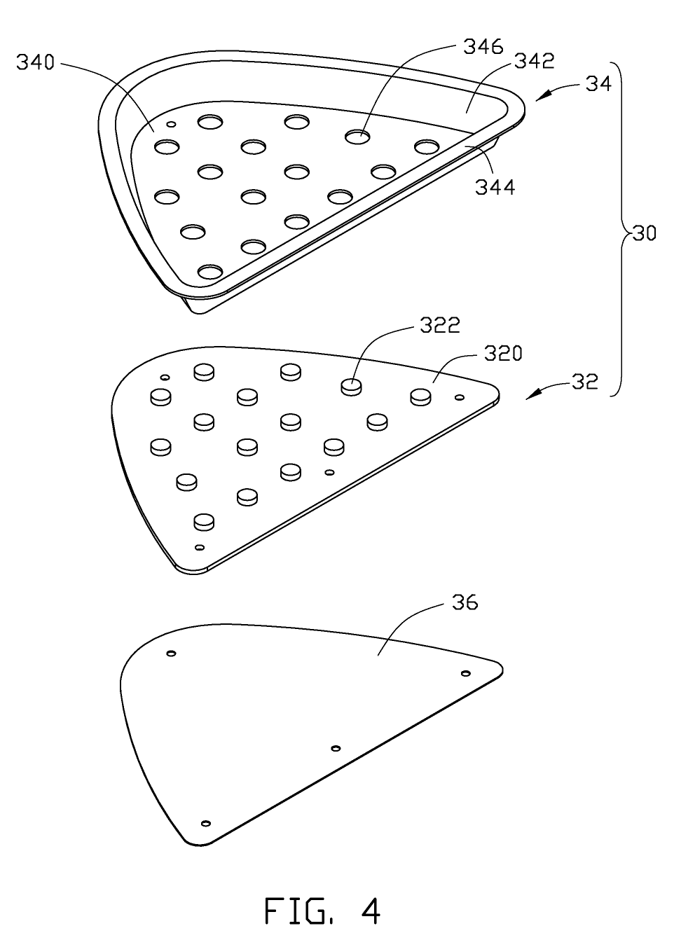

Referring to FIGS. 2-4, the second light source module 30 is sandwiched between the bracket 10 and the lamp shell 20 opposite to the fins 13 of the bracket 10 and in the triangular opening 22 of the lamp shell 20. A heat-absorbing member 36, to which the second light source module 30 is attached, is attached onto a surface 130 at a bottom of the fins 13. The heat-absorbing member 36 is planar and made of materials having high thermal conductivity. The second light source module 30, substantially triangular, comprises a second LED module 32 and a second reflector 34 fixed to the second LED module 32. The second LED module 32 comprises a triangular printed circuit board 320 and a plurality of spaced LEDs 322 evenly mounted on a bottom side of the printed circuit board 320 and facing the envelope 60. The second reflector 34 comprises a substantially triangular base plate 340 and a sidewall 342 extending downwardly from a peripheral edge of the base plate 340. The base plate 340 of the second reflector 34, the printed circuit board 320 of the second LED module 32 and the heat-absorbing member 36 are sequentially connected by fasteners (not shown), which further engage the surface 130 of the bracket 10, securing the second light source module 30 and the heat-absorbing member 36 thereto. A rim 344 extends outwardly and horizontally from a top end of the sidewall 342, abutting a bottom of the lamp shell 20 near the triangular opening 22 thereof, thereby positioning the second LED module 32 therein. The base plate 340 defines a plurality of through holes 346 receiving the LEDs 322 therein. The LEDs 322 face downwardly. The light emitted from the LEDs 322 is reflected by the second reflector 34 to project downwardly.

Referring to FIGS. 2-3, the heat sink 40, integrally formed of materials having high thermal conductivity, comprises a substantially rectangular plate 42, a plurality of spaced parallel fins 44 extending upwardly from a top face of the plate 42, and a plurality of mounting members 46 extending downwardly from a center of a bottom face of the plate 42. Two opposite sides of the plate 42 present two opposite curved configurations corresponding to two middle parts of the profile of the fixing frame 11 of the bracket 10. The plate 42 covers the rectangular opening 110 of the bracket 10, thereby abutting the bottom face thereof to the bracket 10 near a peripheral edge of the rectangular opening 110, and the mounting members 46 extend downwardly through the rectangular opening 110. A plurality of fasteners (not shown) extends through a plurality of holes 420 defined in the two opposite sides of the plate 42, and a plurality of threaded holes 112, defined in the fixing frame 11 and corresponding to the holes 420, mounting the heat sink 40 on the fixing frame 11 of the bracket 10.

The mounting members 46 are symmetrical about a longitudinal central line (not shown) of the bottom face of the plate 42. The mounting members 46 are parallel and spaced. Each mounting member 46 comprises a rectangular extending plate 460 extending downwardly from the bottom face of the plate 42 and a rectangular mounting plate 462 extending slantwise from a bottom end of the extending plate 460. The first light source modules 50 are on bottom faces of the mounting plates 462, respectively. The mounting members 46 are the same length and parallel to each fin 44 of the heat sink 40. Height of the extending plates 460 gradually decreases toward two opposite sides of the plate 42, wherein a pair of extending plates 460 at a central portion of the plate 42 are the same height as each other and larger than other extending plates 460 located near the two opposite sides of the plate 42. Each mounting plate 462 is disposed at an acute angle with respect to the bottom face of the plate 42. The angles between the mounting plates 462 and the bottom face of the plate 42 gradually increase from a central two of the mounting plates 462 toward the two opposite lateral sides of the plate 42, such that a pair of mounting plates 462 at the central portion of the plate 42 forms the same acute angles with the bottom face of the plate 42, less than the angles between the other mounting plates 462 and the bottom face of the plate 42. Thus, light generated by the first light source modules 50 is radiated from the central portion of the plate 42 toward the two opposite lateral sides thereof to increase the illumination angle of the LED lamp.

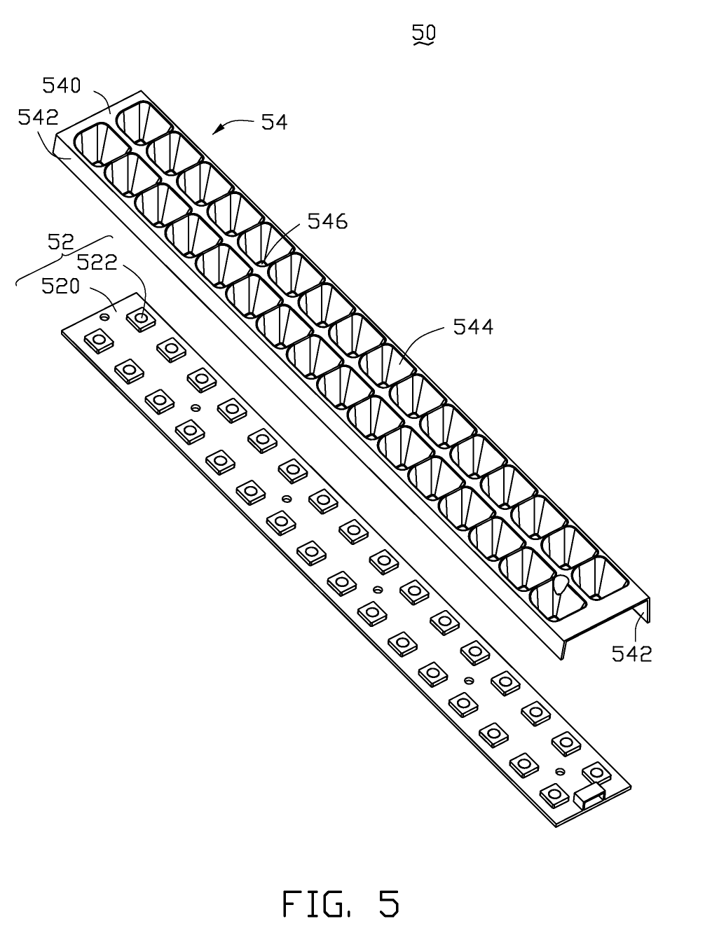

Referring also to FIG. 5, each of the first light source modules 50 comprises an elongated rectangular first LED module 52 and a first reflector 54 fixed thereon. The first LED module 52 comprises a rectangular printed circuit board 520 and a plurality of spaced LEDs 522 evenly mounted on a bottom side of the printed circuit board 520 and facing the transparent envelope 60. The LEDs 522 are arranged into two rows. The first reflector 54 comprises a top wall 540 and two sidewalls 542 extending upwardly from two ends of the top wall 540, respectively. A top face of the top wall 540 is depressed toward the printed circuit board 520 to form a plurality of reflecting walls 544 each of which defines an extending hole 546 in a bottom thereof close to the printed circuit board 520. The extending holes 546 are corresponding to the LEDs 522 and receive the LEDs 522 therein. The first LED modules 52 are secured on the inclined mounting plates 462 of the mounting members 46 to present a wide illumination.

Referring to FIGS. 2-3, the envelope 60, integrally formed of transparent materials such as glass or plastic, comprises a convex portion 62 and a mounting portion 64 extending outwards and horizontally from a peripheral edge of the convex portion 62. The envelope 60 corresponds to the first light source modules 50 and the second light source module 30, and abuts a bottom of the mounting frame 21 of the lamp shell 20. A mounting strip 80, having the same profile as the mounting portion 64 of the envelope 60, abuts the mounting portion 64 of the envelope 60 to mount the envelope 60 on the mounting frame 21 of the lamp shell 20.

Referring to FIG. 2, the driving circuit board 70 comprises a power interface 72 connecting to a power supply (not shown), two light source interfaces 74 connecting the first light source modules 50 and the second light source module 30, respectively, and a chip 76 automatically controlling a brightness of the LED lamp. The chip 76 monitors operational status of the first light source modules 50, and activates the second light source module 30 in response to the operating status of the first light source modules 50. If one of the first LED modules 52 of the first light source modules 50 fails, the chip 76 outputs a signal activating the second light source module 30, thereby compensating for intensity loss of the first light source modules 50 upon failure, and accordingly normalizing overall brightness of the LED lamp.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp comprising:
a bracket;
a plurality of first LED modules mounted on a center of the bracket;
a second LED module mounted on a foreside of the bracket and spaced from the first LED modules; and
a driving circuit board mounted on a rear end of the bracket and electrically connecting with the second LED module and the first LED modules, wherein the driving circuit board automatically monitors operating status of the first LED modules and activates the second LED module in response to failure occurring on at least one of the first LED modules.

2. The LED lamp as claimed in claim 1, wherein the driving circuit board comprises a chip monitoring the first LED modules and two light source interfaces electrically connected to the first LED modules and the second LED module to supply power thereto.

3. The LED lamp as claimed in claim 1, wherein the second LED module is disposed on a bottom side of the bracket, and a heat-absorbing member is sandwiched between the bracket and the second LED module.

4. The LED lamp as claimed in claim 3 further comprising a lamp shell secured to the bottom side of the bracket, and wherein the second LED module and the driving circuit board are received in two opposite ends of the lamp shell.

5. The LED lamp as claimed in claim 4, wherein the lamp shell defines an opening and a window spaced therefrom, with the first LED modules received in the window and located at the same bottom side of the bracket as the second LED module, which is received in the opening.

6. The LED lamp as claimed in claim 5 further comprising a heat sink disposed in the window and located at a top side of the bracket, wherein the first LED modules are disposed on the heat sink.

7. The LED lamp as claimed in claim 6, wherein the heat sink comprises a plate, from a bottom face of which a plurality of mounting members extend downwardly through the window of the lamp shell.

8. The LED lamp as claimed in claim 7, wherein the plurality of mounting members is symmetrical about a longitudinal central line of the bottom face of the plate of the heat sink and spaced from each other.

9. The LED lamp as claimed in claim 8, wherein the mounting members comprise a plurality of mounting plates on which the first LED modules are attached, and angles between the mounting plates and the bottom face of the plate of the heat sink gradually increase from a center of the plate toward two opposite lateral sides of the plate.

10. The LED lamp as claimed in claim 9, wherein the mounting members further comprise a plurality of extending plates extending downwardly from the bottom face of the plate, and the mounting plates angle from bottom ends of the extending plates, and heights of the extending plates gradually decrease from the center of the plate toward the two opposite lateral sides of the plate.

11. The LED lamp as claimed in claim 4 further comprising an envelope on a bottom side of the lamp shell covering the first LED modules and the second LED module.

12. The LED lamp as claimed in claim 6, wherein a plurality of parallel and spaced fins is located at the same top side of the bracket as the heat sink and corresponding to the second LED module.

13. The LED lamp as claimed in claim 12, wherein the heat sink comprises a plurality of spaced fins extending upwardly from a top face of the plate and parallel to the plurality of fins on the bracket corresponding to the second LED module.

14. The LED lamp as claimed in claim 5 further comprising a second, triangular, reflector on the second LED module, from a periphery of a bottom end of which a rim extends outwardly and horizontally.

15. The LED lamp as claimed in claim 14, wherein the rim of the second reflector abuts the lamp shell near a periphery of the opening thereof.

16. The LED lamp as claimed in claim 1, wherein the first LED modules are arranged such that light emitted thereby is distributed in a divergent manner, and LEDs of the second LED module face downwardly.
